(19) United States
(12) Patent Application Publication
(10) Pub. No.: US 2007/0159738 A1
(43) Pub. Date: Jul. 12, 2007

(54) Receptacle providing sustained excessive voltage protection

(75) Inventors: Thomas E. Natili, Penn Township, PA (US); Robert T. Elms, Monroeville, PA (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/327,899

(22) Filed: Jan. 9, 2006

(51) Int. Cl. H02H 3/00

(52) U.S. Cl. 361/42

(57) ABSTRACT

A receptacle for a power circuit includes a receptacle housing, a line terminal structured to receive a voltage including one of a nominal voltage and a greater excessive voltage, a load terminal, a neutral terminal, a load neutral terminal, separable contacts electrically connected between the line and load terminals, an operating mechanism structured to open and close the separable contacts, and a trip mechanism cooperating with the operating mechanism to trip open the separable contacts. The trip mechanism includes a trip circuit structured to detect a first trip condition associated with the power circuit and to responsively actuate the operating mechanism to trip open the separable contacts. The trip mechanism also includes an overvoltage circuit structured to detect a sustained excessive voltage condition between the at least one neutral terminal and the line or the load terminals and to responsively actuate the operating mechanism to trip open the separable contacts.

### BACKGROUND OF THE INVENTION

1. Field of the Invention

This invention pertains generally to electrical switching apparatus and, more particularly, to receptacles.

1. Background Information

Receptacles are outlet circuit interrupters, which are intended to be installed at a branch circuit outlet, such as an outlet box, in order to provide, for example, arc fault and/or ground fault protection of loads.

Known receptacles typically include both a reset button and a test button. The reset button is used to activate a reset cycle, which attempts to reestablish electrical continuity between input and output conductive paths or conductors. While the reset button is depressed, reset contacts are closed to complete a test circuit, in order that a test cycle is activated. The test button also activates the test cycle, which tests the operation of the circuit interrupting mechanism.

Known 120 V_{RMS} ground fault and/or arc fault receptacles are designed to survive the application of 240 V_{RMS}, without tripping or without being damaged. However, if any one or more 120 V_{RMS} loads are downstream and/or are electrically connected to the receptacle, then such loads will most likely be damaged or destroyed by a sustained 240 V_{RMS} overvoltage condition.

Sustained overvoltage conditions can result from a loss of the neutral electrical connection at the upstream utility, load center or circuit breaker. Sustained overvoltage conditions can also occur from certain utility faults. For example, if the neutral is “lost” (e.g., due to an electrical problem; due to a “white” neutral wire being disconnected from the power bus) in a single-pole, two-pole or three-phase power system, then the nominal 120 V_{RMS} line-to-neutral voltage may rise to 208 or 240 V_{RMS}, thereby causing the line-to-neutral MOV(s) in the receptacle to fail (i.e., due to an excessive voltage condition of sufficient duration).

U.S. Pat. No. 6,671,150 discloses overvoltage protection in a circuit breaker by employing an analog circuit (e.g., an MOV; a sidac; a circuit including a diode, a zener diode and two resistors) to detect an excessive voltage condition through a trip coil and responsively energize such trip coil.

There is room for improvement in electrical switching apparatus, such as receptacles.

### SUMMARY OF THE INVENTION

These needs and others are met by the present invention, which provides a receptacle that protects a power circuit from a sustained excessive voltage condition.

In accordance with one aspect of the invention, a receptacle for a power circuit comprises: a receptacle housing; a line conductor structured to receive a voltage including one of a nominal voltage and an excessive voltage, which is greater than the nominal voltage; a load conductor; at least one neutral conductor; at least one set of separable contacts, one set of the at least one set of separable contacts being electrically connected between the line conductor and the load conductor; an operating mechanism structured to open and close the at least one set of separable contacts; and a trip mechanism cooperating with the operating mechanism to trip open the at least one set of separable contacts, the trip mechanism comprising: a first circuit structured to detect a first trip condition associated with the power circuit and to responsively actuate the operating mechanism to trip open the at least one set of separable contacts, and a second circuit structured to detect an excessive voltage condition between the at least one neutral conductor and the line conductor or the load conductor and to responsively actuate the operating mechanism to trip open the at least one set of separable contacts.

The line conductor or the load conductor may include the received voltage; the second circuit may comprise a voltage sensor structured to sense the received voltage of the line conductor or the load conductor and a processor structured to determine if the sensed received voltage is greater than a predetermined value for greater than a predetermined time and to responsively actuate the operating mechanism to trip open the at least one set of separable contacts, in order to protect a load downstream of the load conductor from the excessive voltage condition.

The received voltage of the line conductor may be an alternating current voltage including a plurality of line cycles; the processor may be structured to determine one of an integrated half cycle peak voltage, an average voltage and an RMS voltage from the sensed received voltage; the predetermined value may be one of an integrated voltage value, an average voltage value and an RMS voltage value; and the predetermined time may be at least the duration of at least one of the line cycles.

As another aspect of the invention, a receptacle for a power circuit comprises: a receptacle housing; a line conductor structured to receive a voltage including one of a nominal voltage and an excessive voltage, which is greater than the nominal voltage; a load conductor; at least one neutral conductor; at least one set of separable contacts, one set of the at least one set of separable contacts being electrically connected between the line conductor and the load conductor; an operating mechanism structured to open and close the at least one set of separable contacts; a first circuit structured to detect a first trip condition associated with the power circuit and to responsively actuate the operating mechanism to trip open the at least one set of separable contacts, and a second circuit structured to detect a sustained excessive voltage condition between the at least one neutral conductor and the line conductor or the load conductor and to responsively actuate the operating mechanism to trip open the at least one set of separable contacts.

### BRIEF DESCRIPTION OF THE DRAWINGS

A full understanding of the invention can be gained from the following description of the preferred embodiments when read in conjunction with the accompanying drawings in which:

FIG. 1 is a block diagram of a receptacle in accordance with the present invention.

FIG. 2 is a flowchart of a routine executed by the processor of FIG. 1.

### DESCRIPTION OF THE PREFERRED EMBODIMENTS

The present invention is described in association with an arc fault/ground fault receptacle, although the invention is applicable to a wide range of receptacles.

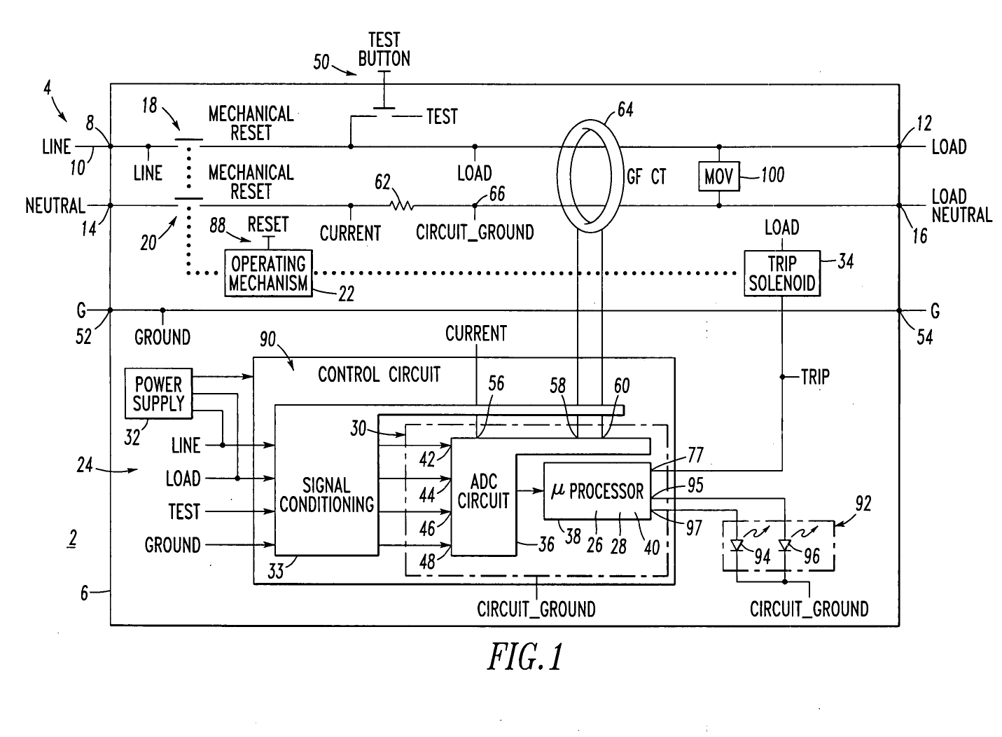

Referring to FIG. 1, a receptacle 2 for a power circuit 4 includes a receptacle housing 6, a line conductor, such as terminal 8, structured to receive a voltage 10 including one of a nominal voltage and an excessive voltage, which is greater than the nominal voltage, a load terminal 12, and one or more neutral terminals, such as 14 and/or 16. One or two sets of separable contacts 18, 20 are provided. One set 18 of the separable contacts is electrically connected between the line terminal 8 and the load terminal 12. Another set 20 of the separable contacts may be electrically connected between the neutral terminal 14 and the load neutral terminal 16. An operating mechanism 22 is structured to open and close the separable contacts 18, 20. A trip mechanism 24 cooperates with the operating mechanism 22 to trip open the separable contacts 18, 20. The trip mechanism 24 includes a first circuit 26 structured to detect a first trip condition associated with the power circuit 4 and to responsively actuate the operating mechanism 22 to trip open the separable contacts 18, 20, and a second circuit 28 structured to detect an excessive voltage condition between the load neutral terminal 16 (or the neutral terminal 14) and the line terminal 8 or the load terminal 12 and to responsively actuate the operating mechanism 22 to trip open the separable contacts 18, 20.

### EXAMPLE 1

The example trip mechanism 24 includes a microcontroller 30, a power supply 32, a signal conditioning circuit 33 and a trip solenoid 34. The microcontroller 30 includes an analog-to-digital converter (ADC) circuit 36 and a microprocessor 38 having a firmware routine 40. The ADC circuit 36 includes a plurality of sensors, such as ADC inputs 42, 44, 46, 48 for sensing voltages respectively corresponding to the line terminal 8 (line), the load terminal 12 (load), a test button 50 (test) and one or more ground terminals 52, 54. The ADC circuit 36 further includes a plurality of sensors, such as ADC inputs 56 and 58, 60, for sensing voltages corresponding to a neutral shunt 62 (current) and the two inputs (sense) from a ground fault current transformer 64, respectively. The microcontroller 30 and the various voltages are referenced to a circuit ground (circuit_ground) on the load neutral side of the neutral shunt 62 at node 66.

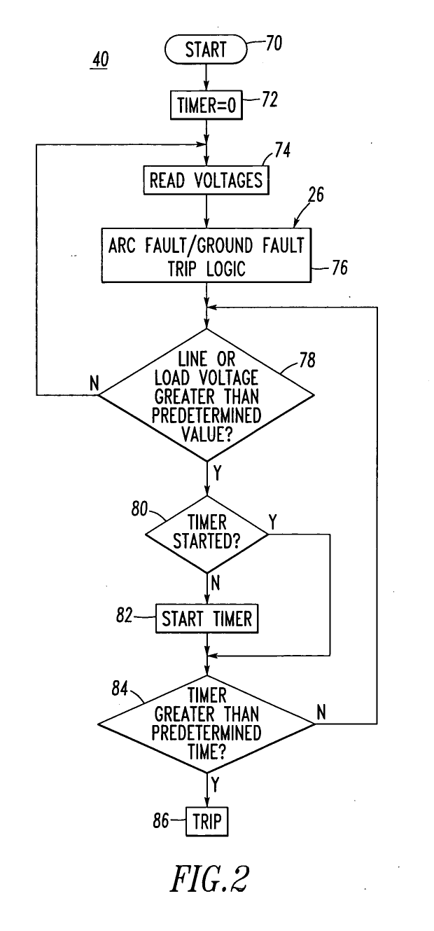

The neutral shunt 62 includes a voltage (current) corresponding to current flowing through the separable contacts 20. The ADC input 56 senses that voltage (current) and provides that sensed voltage for step 76 of FIG. 2, as will be discussed.

The current transformer 64 includes a signal corresponding to the difference between current flowing through the separable contacts 18 and the load terminal 12 and current flowing through the separable contacts 20 and the load neutral terminal 16. The ADC inputs 58, 60 sense this voltage and provide the corresponding value for step 76 of FIG. 2.

### EXAMPLE 2

Referring to FIG. 2, the firmware routine 40 is shown. After starting at 70, a timer (e.g., hardware; firmware) value is set to zero at 72. Next, at 74, the microprocessor 38 reads and suitably processes the various voltages corresponding to the ADC inputs 42, 44, 46, 48, 56, 58, 60. Then, at 76, arc fault/ground fault trip logic is executed to process the current value associated with the ADC input 56 and the two sense inputs from the ground fault current transformer 64 at ADC inputs 58, 60. Under arc fault or ground fault trip conditions, the microprocessor 38 sets a digital output 77, which provides a TRIP signal to the trip solenoid 34, in order to trip open the separable contacts 18, 20. Next, at 78, it is determined if the line voltage associated with the ADC input 42 or the load voltage associated with the ADC input 44 is greater than a predetermined value. If not, then there is an absence of an excessive voltage condition and execution resumes at 74. Otherwise, there is an excessive voltage condition and, at 80, it is determined if the timer (e.g., hardware; firmware) was started. If not, then at 82, the timer is started. Otherwise, or after 82, it is determined if the timer value is greater than a predetermined time. If not, then execution resumes at 78. On the other hand, if the timer value is greater than the predetermined time, then there has been a sustained excessive voltage condition (e.g., the load voltage with respect to the neutral voltage (circuit_ground); the line voltage with respect to the neutral voltage (circuit_ground)) of suitable time and magnitude. Hence, under such sustained excessive voltage condition, at 86, the microprocessor 38 sets the digital output 77, which provides the TRIP signal to the trip solenoid 34, in order to trip open the separable contacts 18, 20. The microprocessor 38 and the firmware routine even steps 78-86, thus, provide the microprocessor-based electronic overvoltage protection circuit 28, while the microprocessor 38 and the firmware routine step 76 provide the microprocessor-based electronic arc fault/ground fault protection circuit 26. Both of step 76 (in the event of an arc fault or ground fault) and step 86 actuate the operating mechanism 22 by issuing the trip signal through digital output 77 to the trip solenoid 34, in order to trip open the separable contacts 18, 20 and protect a load (not shown) downstream of the load terminal 12 from the sustained excessive voltage condition.

### EXAMPLE 3

The received voltage 10 of the line terminal 8 may be an alternating current voltage including a plurality of line cycles. At step 74, the microprocessor routine 40 may be structured to determine one of an integrated half cycle peak voltage, an average voltage and an RMS voltage from the sensed received voltage of ADC input 42.

### EXAMPLE 4

At step 78, the predetermined value may be one of an integrated voltage value, an average voltage value, and an RMS voltage value (e.g., without limitation, about 150 V_{RMS}). At step 84, the predetermined time may be at least the duration of at least one of the line cycles (e.g., without limitation, about 16.67 ms at 60 Hz). Thus, if a sustained excessive voltage above a predetermined threshold for a predetermined time is detected, then the receptacle 2 opens one or both sets of separable contacts 18, 20 to disconnect any attached load(s) or downstream loads from the source of the excessive voltage.

### EXAMPLE 5

The protection circuit 26 may be, for example, one or both of an arc fault protection circuit and a ground fault protection circuit. Non-limiting examples of arc fault detectors are disclosed, for instance, in U.S. Pat. No. 5,224,006, with a preferred type described in U.S. Pat. No. 5,691,869, which is hereby incorporated by reference herein. Non-limiting examples of ground fault detectors are disclosed in U.S. Pat. Nos. 5,293,522; 5,260,676; 4,081,852; and 3,736,468, which are hereby incorporated by reference herein.

### EXAMPLE 6

Although step 78 may employ one or both of the line voltage and the load voltage, preferably, at least the line voltage is sensed for determining a normal, non-excessive voltage condition, or an excessive voltage condition.

### EXAMPLE 7

As is conventional, the operating mechanism 22 preferably includes a suitable reset mechanism, such as RESET button 88, structured to mechanically close the separable contacts 18,20.

### EXAMPLE 8

As is conventional, the trip mechanism 24 preferably includes a suitable test mechanism, such as TEST button 50, structured to initiate one or both of an arc fault protection test and a ground fault protection test. If the test signal at ADC input 46 is active, then suitable signals (not shown) are sent to the control circuit 90 to apply simulated fault signals (not shown) to test the arc fault/ground fault protection. For example, the test button 50 can test the dual function arc fault and ground fault trip logic 76 as disclosed in U.S. Pat. No. 5,982,593, which is hereby incorporated by reference herein.

### EXAMPLE 9

Although two sets of separable contacts 18, 20 are shown, the receptacle 2 may include a single set of separable contacts (e.g., separable contacts 18 electrically connected between the line and load terminals 8, 12).

### EXAMPLE 10

The receptacle 2 preferably includes a suitable indication circuit 92 structured to indicate different fault conditions. For example, the circuit 92 includes a first LED 94 driven by microprocessor output 95 and a second LED 96 driven by microprocessor output 97.

### EXAMPLE 11

Further to Example 10, the LED 96 is red and is structured to indicate at least one of the excessive voltage condition, the arc fault trip condition and the ground fault trip condition, while the LED 94 is green, and when illuminated, indicates a normal receptacle condition with no fault.

### EXAMPLE 12

Further to Example 10, the LED 96, when illuminated, is structured to indicate the arc fault trip condition and the LED 94, when illuminated, is structured to indicate the ground fault trip condition.

### EXAMPLE 13

Further to Example 12, one of the LEDs 94, 96, such as 94, may be structured to indicate the excessive voltage condition by flashing a corresponding pattern, and to indicate one of the arc fault trip condition and the ground fault trip condition by being solidly illuminated.

### EXAMPLE 14

Further to Example 12, both of the LEDs 94, 96, when illuminated, may be structured to indicate the excessive voltage condition.

### EXAMPLE 15

The power supply 32 is preferably powered from both (e.g., through one or more auctioneering diodes (not shown) of the load terminal 12 and the line terminal 8, in order to protect downstream load(s) under normal and reverse fed conditions. Alternatively, the power supply 32 may be powered from at least one of the terminals 8, 12.

### EXAMPLE 16

As shown in FIG. 1, an MOV 100 may be disposed between the load terminal 12 and the load-neutral terminal 16, in order to provide transient voltage protection.

The disclosed receptacle 2 advantageously provides automatic electronic overvoltage protection by sensing line and/or load voltage(s) with respect to a suitable circuit ground reference (e.g., a neutral voltage). If the sustained sensed voltage (e.g., integrated half cycle peak, average, RMS) is above a predetermined value (e.g., without limitation, 150 V_{RMS}) for a predetermined time (e.g., without limitation, one line cycle; a plurality of cycles; a suitable time), then the downstream load(s) are disconnected from the source of the overvoltage.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A receptacle for a power circuit, said receptacle comprising:
a receptacle housing;
a line conductor structured to receive a voltage including one of a nominal voltage and an excessive voltage, which is greater than said nominal voltage;
a load conductor;
at least one neutral conductor;
at least one set of separable contacts, one set of said at least one set of separable contacts being electrically connected between said line conductor and said load conductor;
an operating mechanism structured to open and close said at least one set of separable contacts; and
a trip mechanism cooperating with said operating mechanism to trip open said at least one set of separable contacts, said trip mechanism comprising:
a first circuit structured to detect a first trip condition associated with said power circuit and to responsively actuate said operating mechanism to trip open said at least one set of separable contacts, and
a second circuit structured to detect an excessive voltage condition between said at least one neutral conductor and said line conductor or said load conductor and to responsively actuate said operating mechanism to trip open said at least one set of separable contacts.

2. The receptacle of claim 1 wherein said line conductor or said load conductor includes said received voltage; wherein said second circuit comprises a voltage sensor structured to sense the received voltage of said line conductor or said load conductor and a processor structured to determine if said sensed received voltage is greater than a predetermined value for greater than a predetermined time and to responsively actuate said operating mechanism to trip open said at least one set of separable contacts, in order to protect a load downstream of said load conductor from said excessive voltage condition.

3. The receptacle of claim 2 wherein the received voltage of said line conductor is an alternating current voltage including a plurality of line cycles; wherein said processor is structured to determine one of an integrated half cycle peak voltage, an average voltage and an RMS voltage from said sensed received voltage; wherein said predetermined value is one of an integrated voltage value, an average voltage value and an RMS voltage value; and wherein said predetermined time is at least the duration of at least one of said line cycles.

4. The receptacle of claim 1 wherein said second circuit comprises a voltage sensor structured to sense a voltage between said load conductor and said at least one neutral conductor to detect said excessive voltage condition.

5. The receptacle of claim 1 wherein said second circuit comprises a voltage sensor structured to sense a voltage between said line conductor and said at least one neutral conductor and a processor structured to compare said sensed voltage to a predetermined value to detect an absence of said excessive voltage condition.

6. The receptacle of claim 1 wherein said first circuit is an arc fault protection circuit.

7. The receptacle of claim 6 wherein said second circuit comprises a voltage sensor and a shunt electrically connected in series with said one set of said at least one set of separable contacts, said shunt including a voltage corresponding to current flowing through said one set of said at least one set of separable contacts, said voltage sensor being structured to sense said voltage corresponding to current flowing through said one set of said at least one set of separable contact and provide said sensed voltage to said arc fault protection circuit.

8. The receptacle of claim 1 wherein said first circuit is a ground fault protection circuit.

9. The receptacle of claim 8 wherein said second circuit comprises a voltage sensor and a current transformer operatively associated with said one set of said at least one set of separable contacts, said current transformer including a signal corresponding to a difference between current flowing through said one set of said at least one set of separable contacts and current flowing through said at least one neutral conductor, said voltage sensor being structured to sense the signal of said current transformer and provide said sensed signal to said ground fault protection circuit.

10. The receptacle of claim 1 wherein said operating mechanism comprises a reset mechanism structured to mechanically close said at least one set of separable contacts.

11. The receptacle of claim 1 wherein said first circuit comprises at least one of an arc fault protection circuit and a ground fault protection circuit.

12. The receptacle of claim 1 wherein said at least one set of separable contacts includes a first set of separable contacts and a second set of separable contacts; wherein said at least one neutral conductor includes a neutral conductor and a load neutral conductor; wherein said first set of separable contacts is electrically connected between said line conductor and said load conductor; and wherein said second set of separable contacts is electrically connected between said neutral conductor and said load neutral conductor.

13. The receptacle of claim 1 wherein said first circuit comprises an arc fault trip circuit structured to trip open said at least one set of separable contacts in response to an arc fault trip condition, and a ground fault trip circuit structured to trip open said at least one set of separable contacts in response to a ground fault trip condition.

14. The receptacle of claim 13 wherein said trip mechanism further comprises at least one indicator structured to indicate at least one of said excessive voltage condition, said arc fault trip condition and said ground fault trip condition.

15. The receptacle of claim 14 wherein said at least one indicator includes a first indicator structured to indicate said arc fault trip condition and a second indicator structured to indicate said ground fault trip condition.

16. The receptacle of claim 14 wherein said at least one indicator is a single indicator structured to indicate said excessive voltage condition by flashing a pattern, and to indicate at least one of said arc fault trip condition and said ground fault trip condition by being solidly illuminated.

17. The receptacle of claim 1 wherein said trip mechanism further comprises a power supply powered from at least one of said line conductor and said load conductor.

18. A receptacle for a power circuit, said receptacle comprising:
a receptacle housing;
a line conductor structured to receive a voltage including one of a nominal voltage and an excessive voltage, which is greater than said nominal voltage;
a load conductor;
at least one neutral conductor;
at least one set of separable contacts, one set of said at least one set of separable contacts being electrically connected between said line conductor and said load conductor;
an operating mechanism structured to open and close said at least one set of separable contacts;
a first circuit structured to detect a first trip condition associated with said power circuit and to responsively actuate said operating mechanism to trip open said at least one set of separable contacts, and
a second circuit structured to detect a sustained excessive voltage condition between said at least one neutral conductor and said line conductor or said load conductor and to responsively actuate said operating mechanism to trip open said at least one set of separable contacts.

19. The receptacle of claim 18 wherein at least one of said line conductor and said load conductor includes said received voltage; wherein said second circuit comprises a voltage sensor structured to sense said received voltage and a processor structured to determine if said sensed received voltage is greater than a predetermined value for greater than a predetermined time and to responsively actuate said operating mechanism to trip open said at least one set of separable contacts, in order to protect a load downstream of said load conductor from said sustained excessive voltage condition.

20. The receptacle of claim 19 wherein the received voltage of said line conductor is an alternating current voltage including a plurality of line cycles; wherein said processor is structured to automatically determine one of an integrated half cycle peak voltage, an average voltage and an RMS voltage from said sensed received voltage; wherein said predetermined value is one of an integrated voltage value, an average voltage value and an RMS voltage value; and wherein said predetermined time is at least the duration of at least one of said line cycles.
